(19) United States
(12) Patent Application Publication
(10) Pub. No.: US 2008/0102423 A1
(43) Pub. Date: May 1, 2008

(54) MNEMONIC SPELLING SYSTEM

(76) Inventor: Lisa I. Lyons, Los Angeles, CA (US)

Correspondence Address: SHELDON MAK ROSE & ANDERSON PC, 100 East Corson Street, Third Floor, PASADENA, CA, 91103-3842, US

(21) Appl. No.: 11/925,529

(22) Filed: Oct. 26, 2007

Related U.S. Application Data
(60) Provisional application No. 60/863,228, filed on Oct. 27, 2006.

(51) Int. Cl. G09B 1/40

(52) U.S. Cl. 434/171

(57) ABSTRACT

A spelling device used to strengthen the visual representation of a word to be spelled. The device is a six-row-by-two-column matrix of boxes with two or more letters of the alphabet in each box, or the device is a circle comprising multiple shapes. The letters of the alphabet are located in the boxes or in the multiple shapes in a zigzag, or alternating pattern. Half of the boxes or the multiple shapes are shaded in a zigzag or alternating pattern. A method for using the device comprises the steps of drawing the speller, shading the device in a zigzag or alternating pattern. Placing numbers in the boxes or multiple shapes that correspond to the letters of the word to be spelled. Then, studying the visual pattern of the word noting the location, shading and shape of the box or shape of the numbers and the corresponding letters.

### FIELD

The invention pertains to the field of learning systems and methods, and more specifically to a nontraditional spelling system that is easy to teach and learn.

### BACKGROUND

There are numerous systems for teaching spelling. Among these systems are rote memorization and phonetic learning. Learning proper spelling by rote is a traditional element of elementary education in the United States. The phonics method of teaching reading, which emphasizes the importance of “sounding out” spelling in learning to read, also puts a premium on learning to spell. Divergence from standard spelling is often perceived as an index of stupidity, illiteracy, or lower class standing. It is often stressful and embarrassing for people who cannot spell words correctly. For example, the intelligence of former Vice President Dan Quayle was repeatedly disparaged for correcting a user's spelling of “potato” as “potatoe” at an elementary school spelling bee in Trenton, N.J. on Jun. 15, 1992.

Advantageously, rote memorization is relatively easy to implement as a system for teaching spelling. Teaching spelling generally involves repetitive exercises by the learner, beginning with very basic, simple tasks and progressing through more and more difficult tasks. For example, a teacher supplies a list of words to be memorized and the user commits the words to memory to be recalled later. The list of words supplied by the teacher becomes more complex as learning progresses. Additionally, spelling “rules” are memorized to assist the user in spelling words such as, for example, “i” before “e,” except after “c,” or when sounded as “ay” as in “neighbor” or “weigh.”

Disadvantageously, rote memorization is a time and a resource intensive learning exercise for both the user and the teacher. Teachers must spend significant amounts of hands-on time, particularly with users that have special needs or learning difficulties such as, for example, an English as a second language (ESL) user. Further, this traditional method of learning to spell requires the teacher to interact extensively with the user to give feedback on whether words are being spelled correctly or incorrectly. Rote memorization is also susceptible to subjectivity on the part of either user or teacher. Additionally, rote memorization relies on the discipline, interest, and skills of the user and the teacher.

Further disadvantageously, the traditional method of learning to spell includes problems due to memory retention of the user and problems due to the class pace where the instructor must continue to another subject before the user can fully master the previous subject matter. Most individuals learn at different paces, but classroom instructions are typically conducted at a single pace. The relation between the responses that a learner makes during learning and the feedback that the learner receives is not consistent in group instruction. For example, users that are slow learners must keep up with the group or risk falling behind in the learning process. Conversely, users that learn at a faster pace than that of the classroom instruction risk getting bored or disinterested. Also, divergent spelling that is a popular advertising technique, used to attract attention such as, for example, Dunkin′ Donuts® and Krispy Kreme® employ nonstandard spellings that can confuse a new speller or a poor speller and compound problems in the learning process.

Advantageously, Phonics is the study of the way in which spellings represent the sounds that make up words. It is related to phonetics, which is the study of speech sounds in general. In the United States the term is also sometimes used to refer to a particular instructional design such as that used by the Hooked on Phonics® products. Phonics requires the user to learn the connections between letter patterns and the sounds they represent. Phonics instruction requires the teacher to provide the user with a core body of information about phonics rules, or patterns.

Disadvantageously, phonics must be taught in a systematic sequence of increasingly challenging phonics patterns and must also be explicit in teaching users precisely how the patterns work such as, for example, “this is b, it stands for the /b/ sound.” Additionally, phonics is considered a product of politics and many educators refuse to employ the system. Also, phonics teaches users to parse words into small chunks and reassemble them without connecting to the ideas conveyed in the text. Phonics emphasizes individual sound-symbol correspondences and not the context of the words which can be detrimental to learning to spell.

English has many words that do not follow any particular spelling rule or pattern. Also, English has many words with unusual spellings that we have adopted from other languages. Despite repeated emphasis on the “rules of spelling,” many users are not able to apply the rules in spelling. It takes constant exposure to the same words and/or rote memorization to be able to spell challenging words. Many users who can easily express their thoughts verbally are severely blocked when it comes to writing because of their deficiency in spelling. For example, the following poem, often reprinted and anonymously written, exemplifies the complexity of English spelling:

I take it you already know,

Of tough and bough and cough and dough.

Others may stumble, but not you,

On hiccough, thorough, laugh and through.

Well done! And now you wish, perhaps,

To learn of less familiar traps.

Beware of heard, a dreadful word,

That looks like beard and sounds like bird.

And dead—it's said like bed, not bead,

For goodness' sake, don't call it ‘deed’!

Watch out for meat and great and threat,

(They rhyme with suite and straight and debt).

A moth is not a moth in mother,

Nor both in bother, broth in brother.

And here is not a match for there,

Nor dear and fear for bear and pear.

And then there's dose and rose and lose—

Just look them up—and goose and choose.

And cork and work and card and ward,

And font and front and word and sword.

And do and go and thwart and cart—

Come, come, I've hardly made a start!

A dreadful language? Why man alive!

I'd mastered it when I was five.

These are among the many reasons why traditional teaching methods are inefficient, time-consuming, and cumbersome. It has been shown that regular alphabetic spelling systems make languages easier to learn. Further studies have shown that dyslexia occurs more often among speakers of languages such as English whose orthography differs heavily from the phonology than speakers of languages where the letter-sound correspondence is more regular.

Therefore, there exists a need for a nontraditional spelling device and method that is easy to teach and learn that is not associated with these disadvantages.

### BRIEF DESCRIPTION OF THE DRAWINGS

These and other features, aspects and advantages of the present invention will become better understood with regard to the following description, appended claims, and accompanying figures where:

FIG. 1 is a block diagram of a matrix of boxes as a nontraditional spelling device that is easy to teach and learn according to one embodiment of the present invention;

FIG. 2 is a is a block diagram of the matrix of boxes of FIG. 1 spelling the word buoyant;

FIG. 3 is an enlarged view of the upper left corner matrix box of FIG. 1;

FIG. 4 is an enlarged view of the lower left corner matrix box of FIG. 1;

FIG. 5 is a block diagram of the matrix boxes of FIG. 1 including numbers in the shaded matrix boxes;

FIG. 6 is a block diagram of the matrix boxes of FIG. 1 including numbers in the unshaded matrix boxes;

FIG. 7 is a diagram of a circular spelling device according to one embodiment of the present invention;

FIG. 8 is a diagram of an alphabet filled circular spelling device according to one embodiment of the present invention;

FIG. 9 is a diagram of a method for using a circular spelling device according to one embodiment of the present invention;

### SUMMARY

A nontraditional spelling device that is easy to teach and learn comprising a) one or more than one column; b) one or more than one row located within each of the one or more than one column forming one or more than one cell; and c) one or more than one character printed in the one or more than one cell in an alternating pattern. The one or more than one row, the one or more than one cell, one or more than one column are shaded with a user selected color. The one or more than one character is selected from an alphabet and the one or more than one character is arranged in an alternating pattern. The device where the one or more than one column forms a circle where the one or more than one cell is a triangle or the one or more than one cell is a semicircle.

A method for using the spelling device comprising the steps of: a) memorizing an alphabet by a user; b) drawing one or more than one box comprising one or more than one column and one or more than one row by the user; c) shading one or more than one of the boxes in an alternating pattern by a user; d) writing the alphabet in the boxes in an alternating pattern; e) writing a first number in the box corresponding to a first letter of a word to be spelled; f) writing a second number in the box corresponding to the next letter of the word to be spelled; g) writing consecutively increasing numbers in the box corresponding to the consecutive letter of the word to be spelled; and h) studying the visual pattern of the word, location of the numbers that correspond to the letters of the word in the matrix and the shading of the box where the number is located. The method further comprising the step of optionally writing the second number adjacent to a previously used number if the letter is used more than once, wherein the second number and the previous used number are separated by a separator.

### DETAILED DESCRIPTION

The present invention overcomes the limitations of the prior art by engaging users to use and strengthen a visual representation of a word to be spelled. When users visualize the word to be spelled in their mind after seeing it on the present invention, the users can prompt their memory by asking questions such as, for example: “Is the letter in a shaded or unshaded box?”; “Which corner of the box is the letter?”; “Is the box on the right side or left side?”; “Which row is the box in?”; “Is the letter appearing in a descending order (“a”, “m”, “y”) or ascending order (“g” and “s”)?” The written visual representation of the word to be spelled consciously and unconsciously reinforces in the user the spelling of any word.

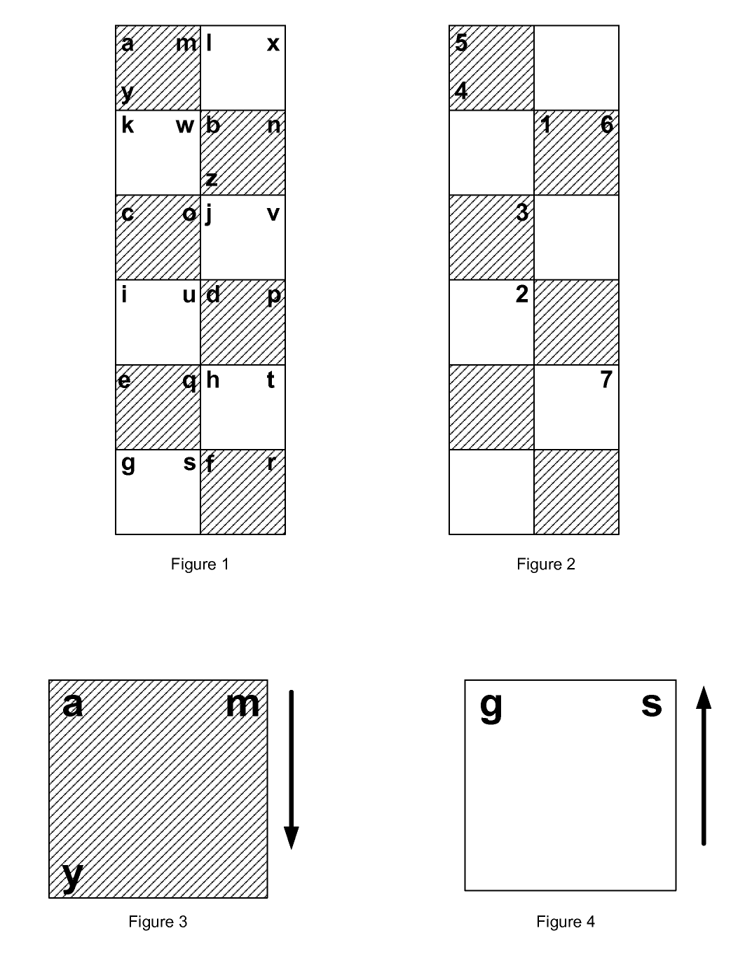

Referring now to FIG. 1, there is shown a six-row-by-two-column matrix of boxes according to one aspect of the present invention. As can be appreciated, one or more than one column and one or more than one row can be arranged in a variety of ways other than what is described herein. In one embodiment, each box comprises two or more letters of the alphabet. The two or more letters of the alphabet are located in the boxes in the matrix in a zigzag, or alternating pattern that is easy to learn. One half of the matrix boxes are shaded in a zigzag or alternating pattern and a user selected color beginning at the top left box of the matrix and zigzagging down to the bottom right box of the matrix. The top left corner of each of the shaded boxes comprises a letter of the alphabet, wherein the letter of the alphabet is “a,” “b,” “c,” “d,” “e,” and “f,” respectively. The top right corner of each of the shaded boxes comprises a letter of the alphabet, wherein the letter of the alphabet is “m,” “n,” “o,” “p,” “q” and “r,” respectively. The bottom left corner of the first two shaded boxes comprises the letters “y” and “z,” respectively. One half of the matrix boxes are unshaded in a zigzag or alternating pattern beginning at the bottom left box of the matrix and zigzagging up to the top right box of the matrix. The bottom left corner of each of the unshaded boxes comprises a letter of the alphabet, wherein the letter of the alphabet is “g,” “h,” “i,” “j,” “k” and “l,” respectively. The top right corner of each of the unshaded boxes comprises a letter of the alphabet, wherein the letter of the alphabet is “x,” “w,” “v,” “u,” “t” and “s,” respectively.

Referring now to FIG. 2, there is shown a diagram of a method for using the present invention for spelling the word “buoyant.” Prior to using the device and method the user must memorize the alphabet. In one embodiment, the method provides a diagram of the present invention. In another embodiment, the method comprises the steps of first drawing the matrix of the mnemonic speller. Then, the user shades the boxes in a zigzag or alternating pattern as described in FIG. 1. Next, a number “1” is placed in the box corresponding to the first letter of the word to be spelled. Then, a number “2” is placed in the box corresponding to the next letter of the word to be spelled. Next, a consecutively increasing number is placed in the box in the matrix corresponding to the next letters of the word to be spelled. If a letter is used more than once, the number is located next to the previous number and separated by a separator such as, for example, a space, a comma or a semi-colon. For example, for the word “appear”, the numbers “2” and “3” would both be located in the upper right hand corner of the box located on the fourth row, second column of the matrix. Then, the user studies the visual pattern of the word noting the location of the numbers that correspond to the letters of the word to be spelled in the matrix and the shading of the box where the number is located. Next, the user studies whether the letters appear in a shaded or unshaded box. Then, the user references the top left matrix box that contains the letters “a,” in the top left corner, “m,” in the top right corner, and “y” in bottom left corner as shown in FIG. 3. Next, the user references the bottom left unshaded matrix box with the letters “g” in the top left corner and “s” in the upper right corner of the matrix box as shown in FIG. 4. The top left and bottom left matrix boxes should be given the most attention initially to orient the user to find the other letters of the alphabet. Then, the user analyzes the location where a particular letter of the word to be spelled appears in relation to the top right and bottom right matrix boxes. For example, given the letter “p”, the user can think of “m, n, and o” which precede the letter “p.” Alternatively, the user can also think of “q,” “r,” and “s” which follow the letter “p.” Next, the user observes that the letter “m” is at the start of the shaded boxes and that the letter “p” will appear in the 4th shaded box.

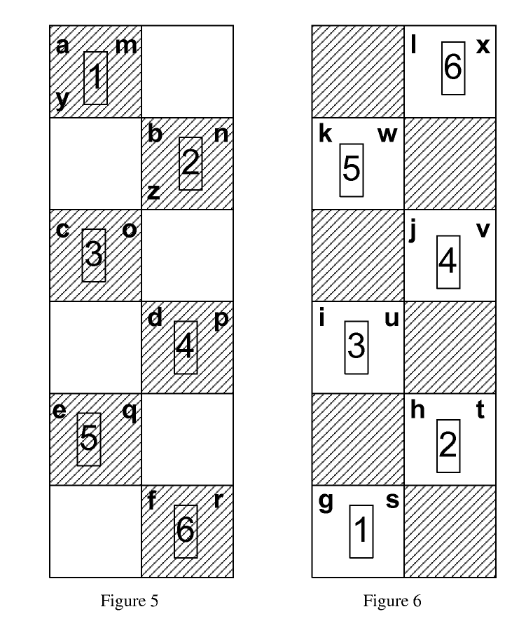

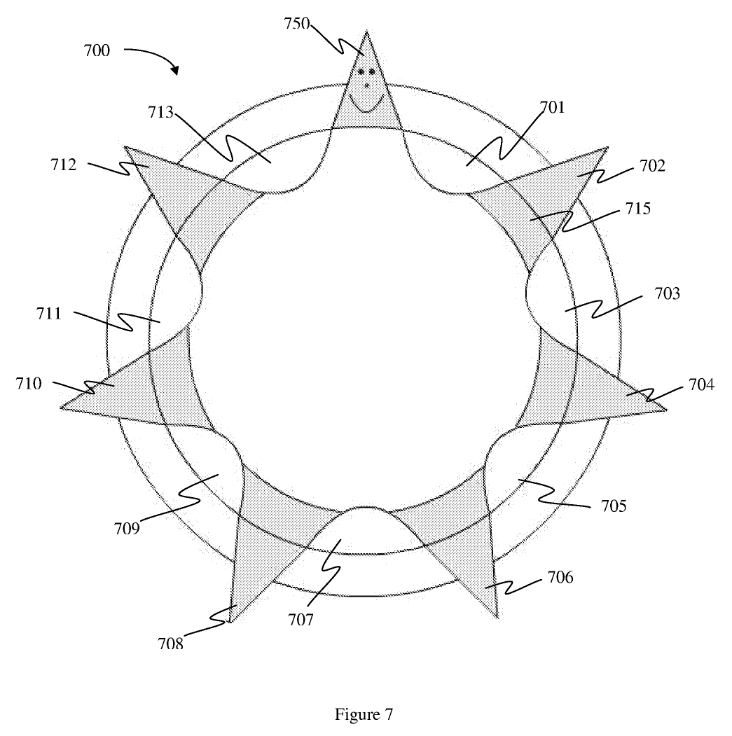

In another embodiment, referring to FIG. 5 and FIG. 6 there is shown a block diagram of the matrix boxes of FIG. 1 including numbers in the shaded matrix boxes and there is shown a block diagram of the matrix boxes of FIG. 1 including numbers in the unshaded matrix boxes, respectively. In another embodiment, the method comprises the steps of first drawing the matrix of the mnemonic speller. Then, the user draws a first matrix of boxes as shown in FIG. 5 and shades the boxes in a zigzag or alternating pattern as described in FIG. 1. Next, a number “1” is placed in the box corresponding to the first shaded matrix box. Then, the numbers “2,” “3,”, “4,” “5” and “6” are placed in the next consecutive shaded matrix boxes from the top to the bottom of the matrix. Next, the user draws a second matrix of boxes as shown in FIG. 6 and shades the boxes in a zigzag or alternating pattern as described in FIG. 1. Then, a number “1” is placed in the bottom left unshaded matrix box. Next, the numbers “2,” “3,” “4,” “5” and “6” are placed in the consecutive unshaded matrix boxes from the bottom to the top of the matrix. Then, the user notes the number, matrix box position and the shading of the matrix box of each letter that corresponds to the letters of the word to be spelled. For example, the word “spell” is represented as: “s”=1-lower left box-unshaded; “p”=4-middle right box-shaded; “e”=5-lower left box-shaded; “l”=6-upper right box-unshaded; “l”=6-upper right box-unshaded.

In a preferred embodiment, the box is recalled from the user's memory and the numbers are placed according to the steps of the method previously described without drawing the device.

Referring to FIG. 7, there is shown another embodiment of the mnemonic spelling system 700. The one or more than one column and one or more than one row are arranged forming a circle. As can be seen, this version of the mnemonic speller incorporates other geometric shapes such as, for example, triangles 702, 704, 706, 708, 710 and 712, and semicircles 701, 703, 705, 707, 709, 711 and 713 in the design as well.

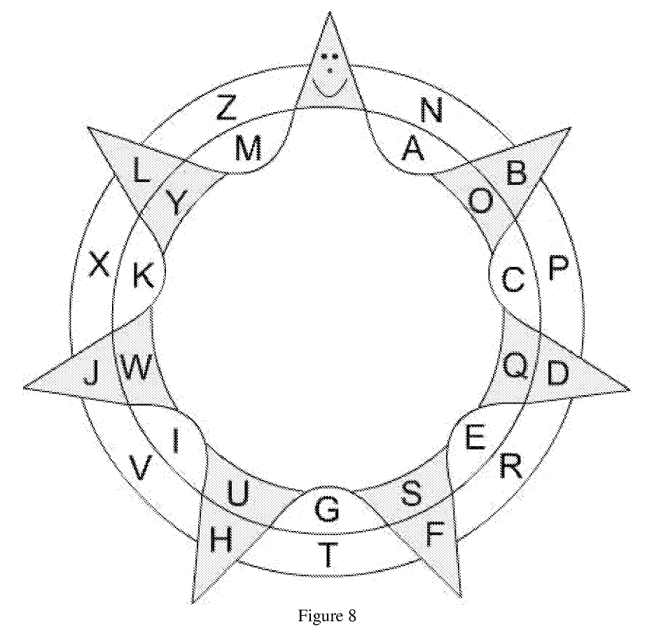

Referring to FIG. 8 there is shown an alphabet filled circular mnemonic speller according to one embodiment of the present invention. As can be seen, the same alternating pattern of letter location and shading is used in a similar fashion to the previous rectangular mnemonic speller described above. The letters of the alphabet progress in a clockwise manner two times around the main circle. The first letter “a” appears on the inside of the circle within a semi-circular shape 701 that is unshaded. The second letter “b” then appears on the outside of the main circle within a shaded triangular shape 702 that is adjacent to the preceding semi-circular one 714. The pattern of the letters continues alternating in and out of the six semicircular and the six triangular shapes of the circle. After letter “m,” that is within the semicircular shape 713 towards the top left, there is an “empty” triangular shape 750. The “empty” triangular shape 750 is to maintain the overall symmetry of the design. However, to make this spelling system fun for the user as well as practical, this empty space could be considered the outline of a “face” upon which the user could use their imagination in adding facial features. The alphabet would proceed with the letter “n” in the semicircular area 714 skipping the empty “face” 750. The letters would then continue beginning with the letter “n” on the opposite side of the semicircular shape 714 and alternating to “o” on the inside of the triangular shape 715 and so on until the letter “z”. The only letters that are shaded are the triangular shapes such as “b”, “d”, “f”, “h”, “j”, and “l” and the letters that appear opposite to them which are “o”, “q”, “s”, “u”, “w”, and “y”.

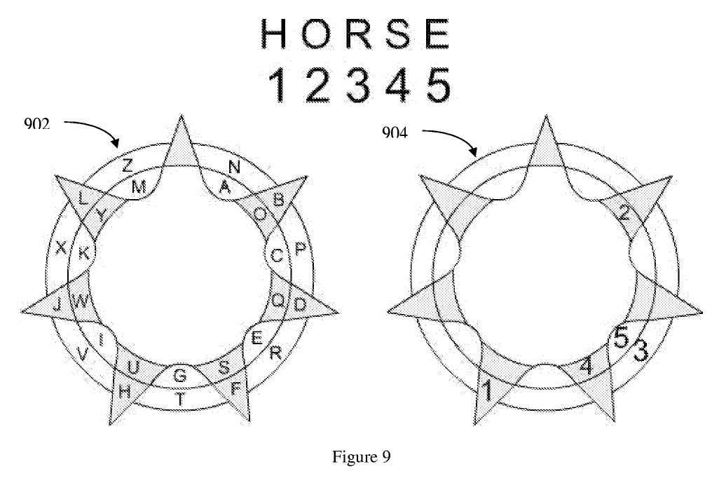

Referring now to FIG. 9, there is shown a diagram of a method for using the present invention for spelling the word “horse.” First, a first speller 902 is provided, where the first speller 902 comprises the letters of the alphabet in the appropriate layout as explained above. Then, a second speller 904 that is blank is placed next to the first speller 902 for writing an ordinal sequence of letters in a word to be spelled. For example to spell the word “horse,” the user first counts the letters in the word to be spelled to avoid omitting a letter in the word. In this case, there are 5 letters. Then, the user will substitute the letters in the word for the ordinal numbers of the word, 1 for h, 2 for o, 3 for r, etc. Next, the numbers will be printed or written onto the blank speller 904 corresponding to the letter location of the first speller 902. Then, the user associates the word to be spelled with the number, position, cell shape and shading of the blank speller 904. These associations will help imprint the sequence of letters in the user's mind.

As can be appreciated, the device and method described can easily be adapted to the alphabets of most romance languages (i.e., Italian, French, Spanish, and Portuguese) whose alphabet closely resemble our own and have relatively the same number of letters. Further, other non-romance languages can benefit from a similar system where the number of cells created for the mnemonic device is increased or decreased to compensate for the actual letters in the alphabet of the particular language being adapted.

In another preferred embodiment, the device comprises a computer program that displays the matrix boxes as described. Additionally, the computer program can speak the word to be spelled and recite a definition of the word to be spelled to incorporate the user's auditory senses reinforcing the spelling of the word. The computer program can systematically place numbers in the matrix boxes and progressing to the next number/letter pair after the user indicates a readiness to proceed such as, for example, pressing the space bar on a keyboard or clicking a mouse button. Additionally, various speed drills or game simulations can be employed to educate and entertain the user. Also, the computer program can highlight the letters substituted on a “blank” matrix box diagram in the correct numerical sequence.

Although the present invention has been discussed in considerable detail with reference to certain preferred embodiments, other embodiments are possible. Therefore, the scope of the appended claims should not be limited to the description of preferred embodiments contained in this disclosure. All references cited herein are incorporated by reference in their entirety.

What is claimed is:

1. A nontraditional spelling device that is easy to teach and learn comprising:
a) one or more than one column;
b) one or more than one row located within each of the one or more than one column forming one or more than one cell; and
c) one or more than one character printed in the one or more than one cell in an alternating pattern.

2. The device of claim 1, where one or more than one row is shaded with a user selected color.

3. The device of claim 1, where one or more than one cell is shaded with the user selected color.

4. The device of claim 1, where one or more than one column is shaded with the user selected color.

5. The device of claim 1, where the one or more than one character is selected from an alphabet.

6. The device of claim 1, where the one or more than one character is arranged in an alternating pattern.

7. The device of claim 1, where the one or more than one column forms a circle.

8. The device of claim 1, where the one or more than one cell is a triangle.

9. The device of claim 1, where the one or more than one cell is a semicircle.

10. A method for using a nontraditional spelling device that is easy to teach and learn, the method comprising the steps of:
a) memorizing an alphabet by a user;
b) drawing one or more than one box comprising one or more than one column and one or more than one row by the user;
c) shading the one or more than one of box in an alternating pattern by a user;
d) writing the alphabet in the one or more than one box in an alternating pattern;
e) writing a first number in the one or more than one box corresponding to a first letter of a word to be spelled;
f) writing a second number in the one or more than one box corresponding to the next letter of the word to be spelled;
g) writing a consecutively increasing number in the one or more than one box corresponding to the consecutive letter of the word to be spelled; and
h) studying the visual pattern of the word, location of the numbers that correspond to the letters of the word in the matrix and the shading of the one or more than one box where the consecutively increasing number is located.

11. The method of claim 10, further comprising the step of optionally writing the second number adjacent to a previously used number if the letter is used more than once, wherein the second number and the previous used number are separated by a separator.
